(19) United States
(12) Patent Application Publication
(10) Pub. No.: US 2010/0312156 A1
(43) Pub. Date: Dec. 9, 2010

(54) Eccentrically Rotatable Massaging Device

(76) Inventor: Dong-Her Wu, Pu Yen Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/480,897

(22) Filed: Jun. 9, 2009

(51) Int. Cl. A61H 15/00

(52) U.S. Cl. 601/112

(57) ABSTRACT

A massaging device includes a rotation member (30), a follower (20) mounted on the rotation member to rotate in concert with the rotation member, and a massaging member (10) having a first end mounted on the follower to rotate in concert with the follower and an open second end having a periphery provided with a curved massaging lip (13). Thus, the massaging lip of the massaging member has a convex resting portion (14) abutting the user's chest so that the massaging lip of the massaging member has a planar arcuate area contacting with the user's chest so as to provide a comfortable sensation to the user.

### BACKGROUND OF THE INVENTION

1. Field of the Invention

The present invention relates to a massaging device and, more particularly, to an eccentrically rotatable massaging device to massage a user's chest or face.

2. Description of the Related Art

A conventional massaging device in accordance with the prior art shown in FIGS. 7 and 8 comprises a drive unit 60 and a massaging member 50 mounted on the drive unit 60. The drive unit 60 includes a hollow holding member 62, an arcuate cover plate 61 mounted on the holding member 62, a drive shaft 65 rotatably mounted on the cover plate 61, a drive motor (not shown) mounted in the holding member 62 and connected with the drive shaft 65 to rotate the drive shaft 65, a rotation member 63 having a central portion mounted on the drive shaft 65 to rotate in concert with the drive shaft 65, and a fixing rod 64 mounted on the rotation member 63 eccentrically to rotate in concert with the rotation member 63. The massaging member 50 has an outer portion provided with a protruding tube 51 which has a mounting hole 511 mounted on the fixing rod 64 to move in concert with the fixing rod 64 and an inner portion provided with a plurality of massaging bosses 52.

In operation, the drive shaft 65 is rotated by the drive motor to rotate the rotation member 63 which rotates the fixing rod 64 which rotates the protruding tube 51 which rotates the massaging member 50 so that the massaging member 50 is rotated eccentrically. Thus, when the edge 53 of the massaging member 50 rests one a user's chest, the massaging member 50 is rotated eccentrically to knead, rub, and press the user's chest slowly so as to provide a massaging effect to the user's chest.

However, the edge 53 of the massaging member 50 contacts with the user's chest in a line-contact manner so that the force applied by the massaging member 50 on the user's chest is concentrated at a determined region, thereby easily causing a painful sensation to the user. In addition, the edge 53 of the massaging member 50 contacts with the user's chest in a line-contact manner so that the massaging member 50 has a smaller contact area with the user's chest and cannot massage the user's chest completely, thereby decreasing the massaging effect of the massaging member 50.

### BRIEF SUMMARY OF THE INVENTION

In accordance with the present invention, there is provided a massaging device, comprising a rotation member, a follower mounted on the rotation member to rotate in concert with the rotation member, and a massaging member having a first end mounted on the follower to rotate in concert with the follower and an open second end having a periphery provided with a curved massaging lip.

Preferably, the massaging lip of the massaging member is bent radially and inward toward the first end of the massaging member.

Preferably, the massaging lip of the massaging member has a side provided with a convex resting portion.

Preferably, the massaging lip of the massaging member has a substantially C-shaped cross-sectional profile.

Preferably, the massaging lip of the massaging member has an inner portion provided with a space.

Preferably, the space of the massaging lip has a side provided with an opening, and the massaging lip of the massaging member is made flexible by provision of the opening.

The primary objective of the present invention is to provide a massaging device having a softly and evenly massaging effect.

Another objective of the present invention is to provide a massaging device, wherein the massaging lip of the massaging member has a convex resting portion abutting the user's chest so that the massaging lip of the massaging member has a planar arcuate area contacting with the user's chest so as to provide a comfortable sensation to the user.

A further objective of the present invention is to provide a massaging device, wherein the resting portion of the massaging lip has a larger area contacting with the user's chest to rub the user's chest completely so as to enhance the massaging effect of the massaging member.

A further objective of the present invention is to provide a massaging device, wherein the massaging lip of the massaging member can be compressed and deformed by provision of the space so that the massaging lip of the massaging member can rest on the user's chest closely and exactly to distribute a force on the user's chest evenly and smoothly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a massaging device in accordance with the preferred embodiment of the present invention.

FIG. 2 is an exploded perspective view of the massaging device as shown in FIG. 1.

FIG. 3 is a front cross-sectional view of the massaging device as shown in FIG. 1.

FIG. 4 is a schematic operational view of the massaging device as shown in FIG. 3 in use.

FIG. 5 is a schematic side operational view of the massaging device as shown in FIG. 1 in use.

FIG. 6 is a front cross-sectional view of a massaging device in accordance with another preferred embodiment of the present invention.

FIG. 7 is a front cross-sectional view of a conventional massaging device in accordance with the prior art.

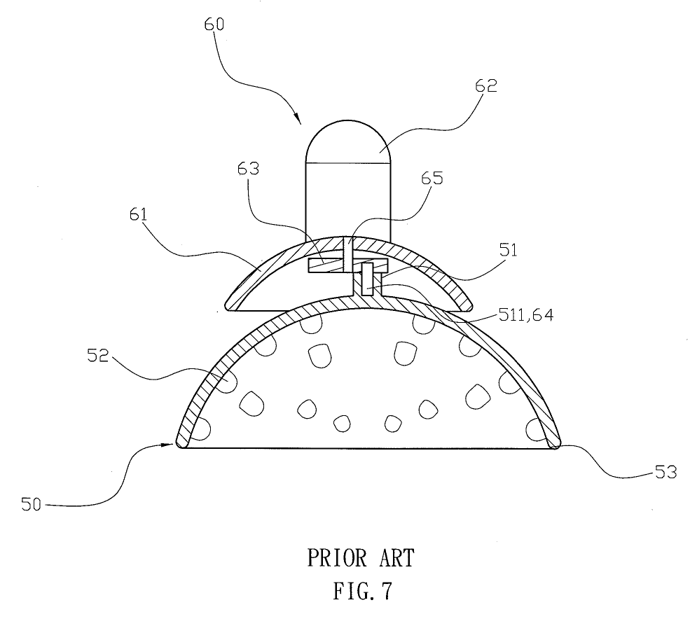

FIG. 8 is a schematic operational view of the conventional massaging device as shown in FIG. 7 in use.

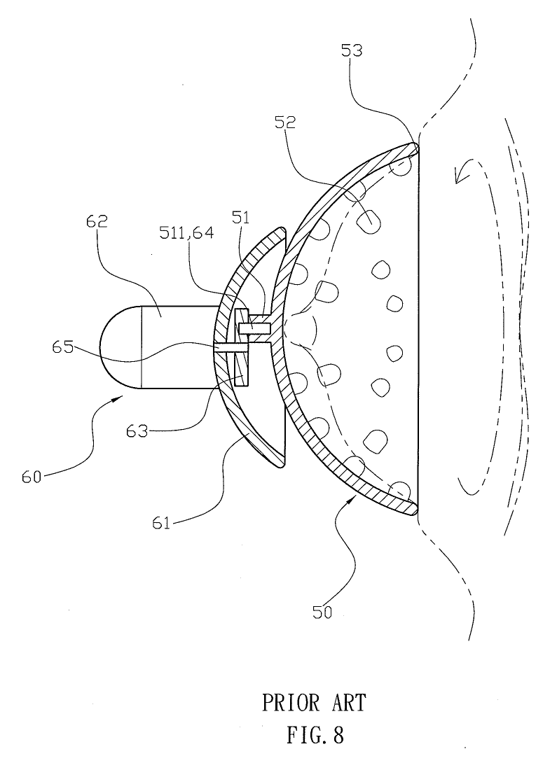

### DETAILED DESCRIPTION OF THE INVENTION

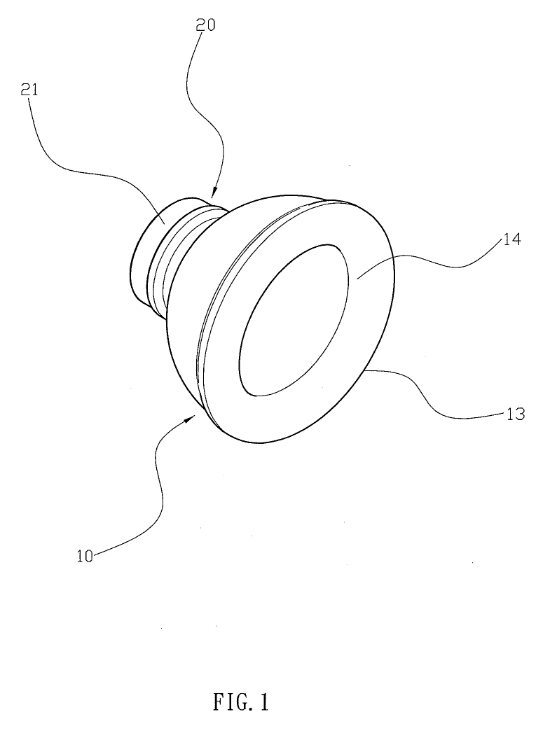

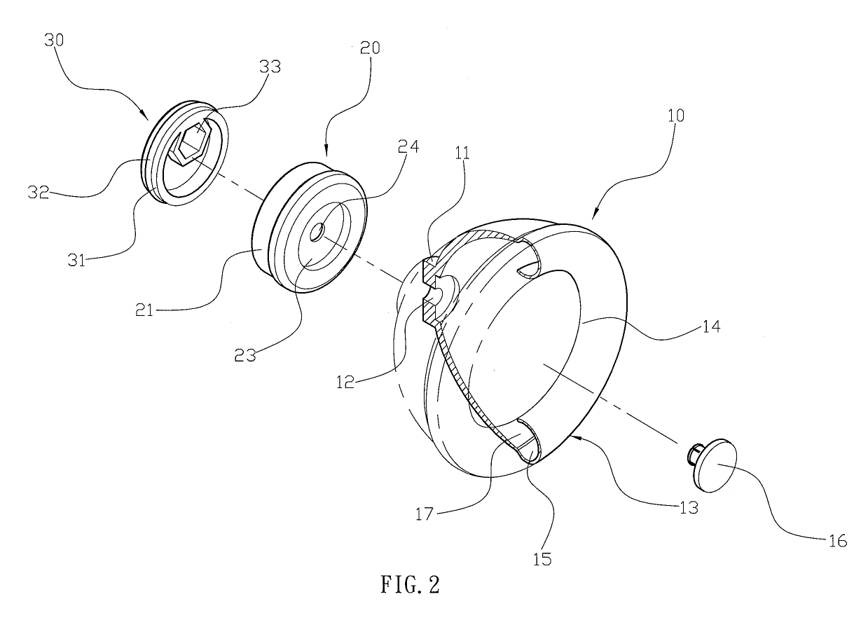

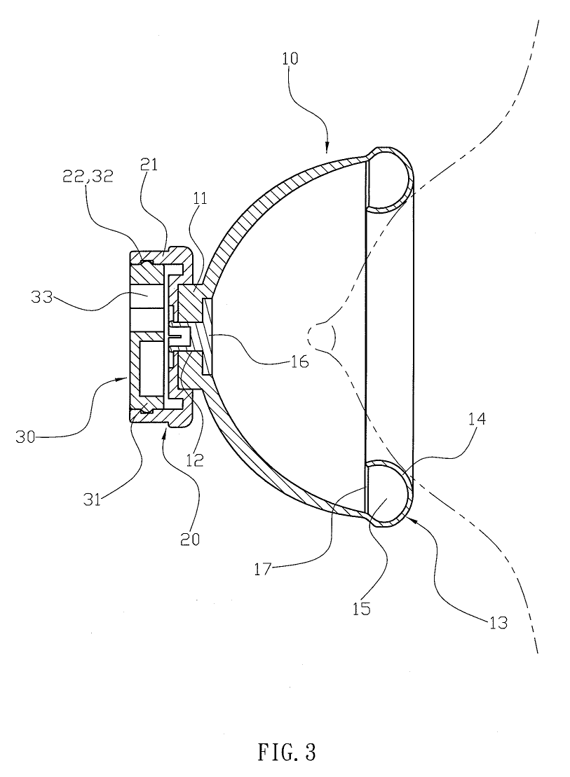

Referring to the drawings and initially to FIGS. 1-3, a massaging device in accordance with the preferred embodiment of the present invention comprises a rotation member 30, a follower 20 mounted on the rotation member 30 to rotate in concert with the rotation member 30, a massaging member 10 having a first end mounted on the follower 20 to rotate in concert with the follower 20 and an open second end having a periphery provided with a curved massaging lip 13, and a fastening member 16 extending through the massaging member 10 and the follower 20 to combine the massaging member 10 and the follower 20 together.

The rotation member 30 has an inner portion provided with an eccentrically arranged drive hole 33. The drive hole 33 of the rotation member 30 has a substantially polygonal shape and is deviated from a central portion of the rotation member 30. The rotation member 30 has an outer portion provided with a first annular wall 31. The first annular wall 31 of the rotation member 30 has an annular retaining flange 32.

The follower 20 is rotatable relative to the rotation member 30. The follower 20 has a central portion provided with a fixing hole 24 to fix the fastening member 16. The follower 20 has a first side provided with a second annular wall 21 rotatably mounted on the first annular wall 31 of the rotation member 30 and a second side provided with a receiving recess 23. The second annular wall 21 of the follower 20 has an annular retaining groove 22 rotatably mounted on the retaining flange 32 of the first annular wall 31 of the rotation member 30.

The massaging member 10 is rotatable relative to the follower 20. The massaging member 10 has a bowl shape and is integrally formed by a resilient material, such as silicone and the like. The first end of the massaging member 10 has an inner portion provided with a stepped receiving hole 12 to receive the fastening member 16 and an outer portion provided with a protruding insert 11 inserted into the receiving recess 23 of the follower 20 so that the insert 11 of the massaging member 10 is rotatable relative to the receiving recess 23 of the follower 20. The massaging lip 13 of the massaging member 10 is bent radially and inward toward the first end of the massaging member 10. The massaging lip 13 of the massaging member 10 has a side provided with a convex resting portion 14. The massaging lip 13 of the massaging member 10 has a substantially C-shaped cross-sectional profile and has an inner portion provided with a space 15. The space 15 of the massaging lip 13 has a side provided with an opening 17 so that the massaging lip 13 of the massaging member 10 is made flexible by provision of the opening 17. The space 15 of the massaging lip 13 is located between the opening 17 and the resting portion 14.

The fastening member 16 extends through the receiving hole 12 of the massaging member 10 and is secured in the fixing hole 24 of the follower 20.

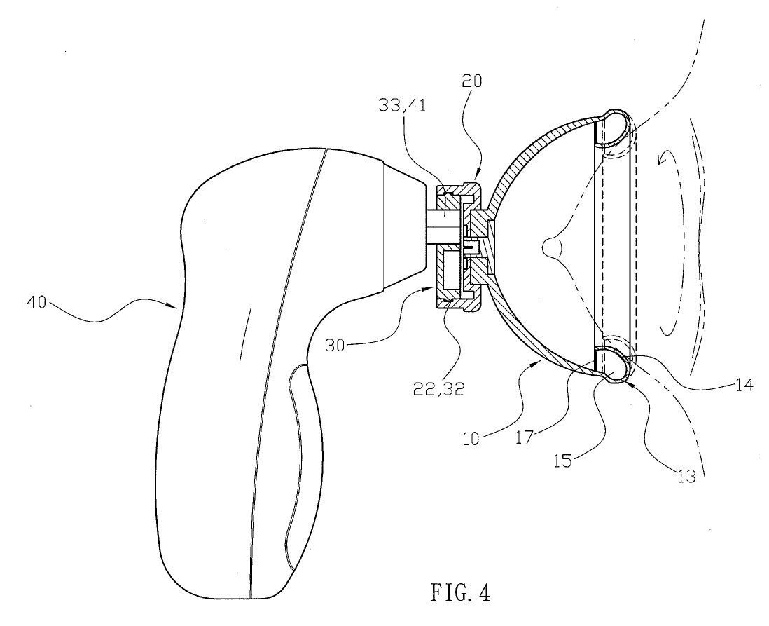

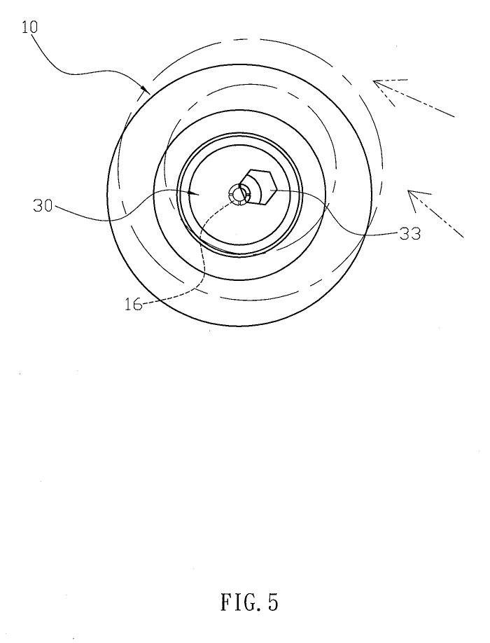

In operation, referring to FIGS. 4 and 5 with reference to FIGS. 1-3, the massaging device further comprises a drive unit 40 having a polygonal drive shaft 41 which is inserted into the drive hole 33 of the rotation member 30 to rotate the rotation member 30 in an eccentric manner so that the follower 20 and the massaging member 10 are also rotated eccentrically. In such a manner, when the massaging member 10 is placed on a user's chest, the massaging member 10 is rotated eccentrically to knead, rub, revolve and press the user's chest slowly so as to provide a massaging effect to the user's chest.

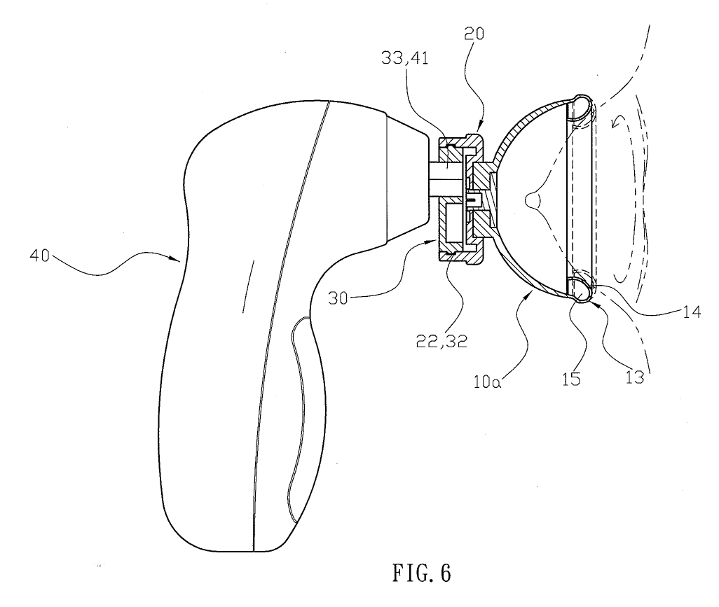

As shown in FIGS. 4 and 6, the rotation member 30 can be removed from the drive shaft 41 of the drive unit 40 for replacement of the massaging member 10.

Accordingly, the massaging lip 13 of the massaging member 10 has a convex resting portion 14 abutting the user's chest so that the massaging lip 13 of the massaging member 10 has a planar arcuate area contacting with the user's chest so as to provide a comfortable sensation to the user. In addition, the resting portion 14 of the massaging lip 13 has a larger area contacting with the user's chest to rub the user's chest completely so as to enhance the massaging effect of the massaging member 10. Further, the massaging lip 13 of the massaging member 10 can be compressed and deformed by provision of the space 15 so that the massaging lip 13 of the massaging member 10 can rest on the user's chest closely and exactly to distribute a force on the user's chest evenly and smoothly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A massaging device, comprising:
a rotation member (30);
a follower (20) mounted on the rotation member to rotate in concert with the rotation member;
a massaging member (10) having a first end mounted on the follower to rotate in concert with the follower and an open second end having a periphery provided with a curved massaging lip (13).

2. The massaging device of claim 1, wherein the massaging lip of the massaging member is bent radially and inward toward the first end of the massaging member.

3. The massaging device of claim 1, wherein the massaging lip of the massaging member has a side provided with a convex resting portion (14).

4. The massaging device of claim 1, wherein the massaging lip of the massaging member has a substantially C-shaped cross-sectional profile.

5. The massaging device of claim 4, wherein the massaging lip of the massaging member has an inner portion provided with a space (15).

6. The massaging device of claim 5, wherein
the space of the massaging lip has a side provided with an opening (17);
the massaging lip of the massaging member is made flexible by provision of the opening.

7. The massaging device of claim 6, wherein the space of the massaging lip is located between the opening and the resting portion.

8. The massaging device of claim 1, wherein the rotation member has an inner portion provided with an eccentrically arranged drive hole (33).

9. The massaging device of claim 8, wherein the drive hole of the rotation member has a substantially polygonal shape.

10. The massaging device of claim 8, wherein the drive hole of the rotation member is deviated from a central portion of the rotation member.

11. The massaging device of claim 1, wherein
the rotation member has an outer portion provided with a first annular wall;
the follower has a first side provided with a second annular wall rotatably mounted on the first annular wall of the rotation member.

12. The massaging device of claim 11, wherein
the first annular wall of the rotation member has an annular retaining flange;
the second annular wall of the follower has an annular retaining groove rotatably mounted on the retaining flange of the first annular wall of the rotation member.

13. The massaging device of claim 11, wherein
the follower has a second side provided with a receiving recess;
the first end of the massaging member an outer portion provided with a protruding insert inserted into the receiving recess of the follower.

14. The massaging device of claim 13, wherein the insert of the massaging member is rotatable relative to the receiving recess of the follower.

15. The massaging device of claim 1, further comprising:
a fastening member extending through the massaging member and the follower to combine the massaging member and the follower together.

16. The massaging device of claim 15, wherein the first end of the massaging member has an inner portion provided with a stepped receiving hole to receive the fastening member.

17. The massaging device of claim 16, wherein the follower has a central portion provided with a fixing hole to fix the fastening member.

18. The massaging device of claim 17, wherein the fastening member extends through the receiving hole of the massaging member and is secured in the fixing hole of the follower.

19. The massaging device of claim 1, wherein the massaging member is integrally formed by a silicone.

20. The massaging device of claim 1, wherein
the follower is rotatable relative to the rotation member;
the massaging member is rotatable relative to the follower.
